(19) United States
(12) Patent Application Publication
(10) Pub. No.: US 2008/0232582 A1
(43) Pub. Date: Sep. 25, 2008

(54) Method for Dynamically Authenticating Programmes with an Electronic Portable Object

(75) Inventors: Benoit Chevallier-Mames, Cassis (FR); David Naccache, Paris (FR); Pascal Paillier, Paris (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/593,411

(22) PCT Filed: Feb. 25, 2005
(86) PCT No.: PCT/EP05/50828

§ 371 Date: Jan. 29, 2007

(30) Foreign Application Priority Data
Mar. 19, 2004 (FR) 0450553

(51) Int. Cl. H04L 9/32

(52) U.S. Cl. 380/44

(57) ABSTRACT

A method for dynamically authenticating an executable program, that is the continuation of the instructions defined thereby, is performed repeatedly during the very execution of the program. The method for making secure an electronic portable object through execution of a program supplied by another insecure electronic object uses, inter alia, a secret key protocol.

This patent describes a method for dynamically authenticating the contents of an executable program, i.e. the succession of instructions defined by said program. More precisely, the program is authenticated repeatedly during execution proper of said program.

The operating principle of the invention makes it possible to design a novel type of secure element referred to as an “Externalized Microprocessor” or “XμP” which, unlike other computation devices such as the smart card (which is the subject of numerous patents such as, for example, FR 2 266 222), does not contain any program memory (conventionally referred to as “Read-Only Memory” or “ROM”). Unlike conventional devices, the XμP can execute programs that are transmitted to it with total security at the very time at which they are being executed.

The advantages of a ROM-free mobile computation device compared with conventional on-board computation technologies (the smart card, i.e. a card equipped with a chip, is taken as the reference technology) are exceptional:
masking, i.e. the industrial operation during which a specific ROM is etched, totally disappears;
bug correction is reduced to updating programs that are stored in the hard disks of the terminals or on a communications network such as the Internet, and therefore does not require withdrawal from the market or renewal of defective smart cards; and
even more importantly, program size is no longer a limiting factor.

The latter advantage is particularly attractive since the technological trend has always been to have the smart card execute programs that are increasingly complex and thus that are increasingly voluminous. From an industrial and operational point of view, a smart card is a miniature computer. A small volatile “Random Access Memory” (“RAM”) on board with the microprocessor serves to store temporary results of a computation, and the microprocessor of the chip executes a program written in non-modifiable manner in the ROM: the person skilled in the art uses the term of “etching”, the etching taking place during the “masking” step. That program can then not be modified in any way.

In order to store data that is specific to the user, chips contain non-volatile “Electrically Erasable Programmable Read-Only Memories” (“EEPROMs”) or “Flash” memories, these two types of memory being suitable for allowing hundreds of thousands of both read accesses and write accesses. Java cards, which are special smart cards, make it possible to import executable programs or “applets” into their non-volatile memories depending on the needs of the holder of the card. In addition, the latest generation of Java cards take on board a link editor or “linker”, a loader module or “loader”, a Java virtual machine, a “remote method invocation module”, an applet verifier or “bytecode verifier”, a firewall for resident Java applications or “applet firewall”, a “garbage collector”, cryptographic libraries, complex stack managers, etc.

Finally, a smart card has a communications port for interchanging check information and data with the outside world. A conventional communications rate is 9,600 bits per second, but much higher rates compatible with the standard defined by the International Organization for Standardization (ISO) are generally used (from 19,200 bits per second to 115,200 bits per second). The appearance of the Universal Serial Bus (USB) protocol in the smart card sector has opened up new prospects and makes it easy to achieve data rates of the order of one megabit per second. In this context, it is tempting to extract the ROM from the operating model of the smart card, and to rely on an ultra-fast communications protocol for transmitting the programs that it used to contain whenever necessary.

However, having a mobile device execute an executable program transmitted by a terminal that is potentially insecure and malevolent poses major security problems. The essential problem of such an approach lies in the presence of cryptographic keys stored in the memory of the device itself. A malevolent program (which is therefore distinct from the programs that are executed legitimately on the device) could attempt to reveal or to modify the values of said keys, thereby totally invalidating the security of the applications using them to operate.

The invention described below makes it possible to solve that problem very effectively by means of symmetrical cryptography functions (also referred to as “secret-key cryptography”) that are conventional and effective: one Message Authentication Code (MAC) function and a few hash functions.

The hash functions are referenced HASH₁, HASH₂, and HASH₃ in the patent. As in the state of the art, these functions are defined by a compression function. By definition, it is said that HASH is a hash function defined by a compression function H and by a constant IV (for “Initialization Vector”), when the following definition applies:
HASH (a₁, a₂, . . . , aₖ)=H(HASH (a₁, . . . , aₖ₋₁),aₖ) with the following special case:
HASH (a₁)=H(IV, a₁)

where the integers a₁, a₂, . . . , aₖ designate the arguments of the hash function.

In this document, we thus use the hash functions HASH₁, HASH₂, and HASH₃ that are respectively defined by (H₁, IVᵢ), (H₂, IV₂) and (H₃, IV₃) .

Thus, the result of a hash is computed iteratively by means of a loop and a plurality of calls to the compression function determining the hashing. Such hash functions are very conventional in cryptography: for example, mention might be made of the SHA and MD5 hash functions whose specifications are based on the description given above.

The present invention will be understood more easily with reference to the accompanying figures, in which:

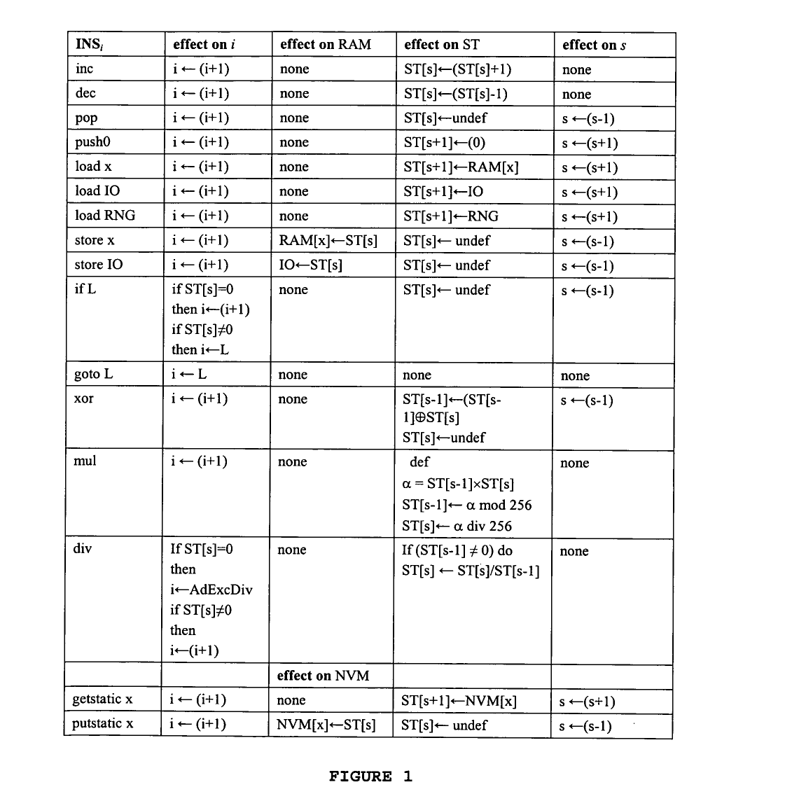

FIG. 1 describes the dynamic semantics of an example of a set of instructions referred to as “XJVML” making it possible to illustrate in non-limiting manner various implementations of the invention;

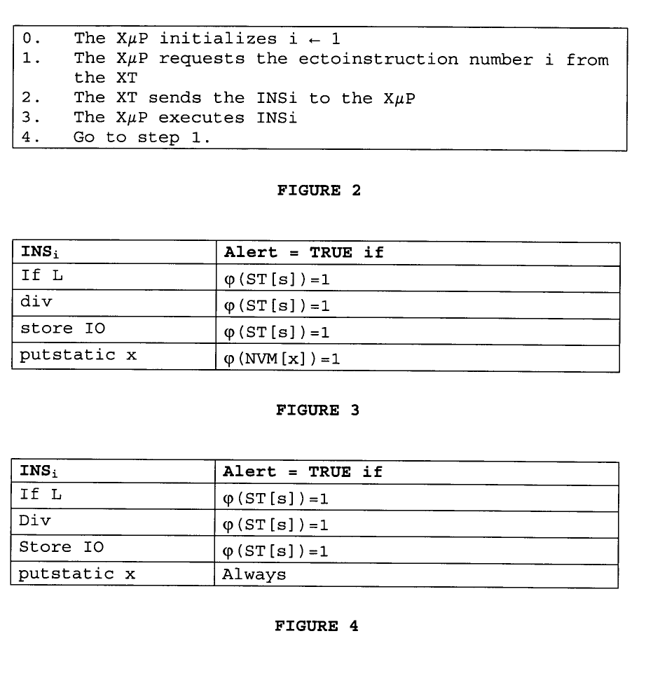

FIG. 2 describes the naïve method of the state of the art making it possible, in non-secure manner, to execute a program P supplied by the outside world to the XμP;

FIG. 3 describes a security policy in XJVML of the invention, authorizing reading and writing of “public” data;

FIG. 4 describes a security policy in XJVML of the invention, authorizing only reading of “public” data; and

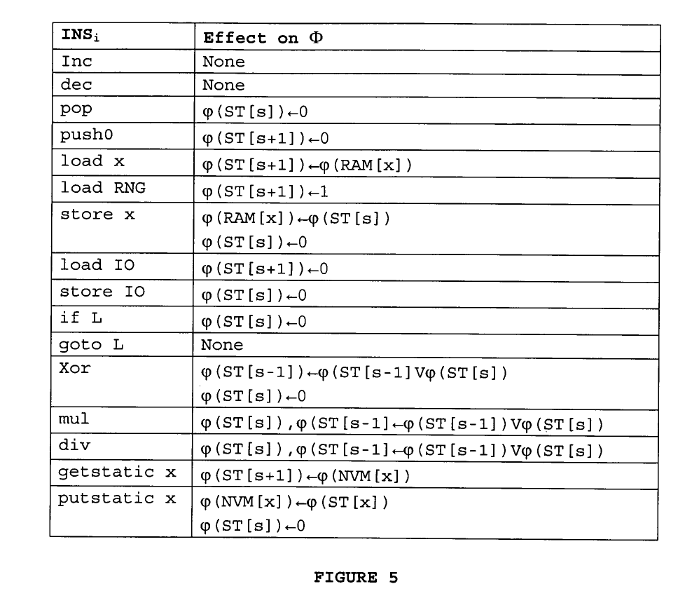

FIG. 5 explains how the security policy is managed during execution of the program P.

In the remainder of the text below, a given program P is examined that is defined over a set of instructions (or programming language) as being an ordered succession of instructions:

1: INS₁

2: INS₂

F: INS_{F}

these instructions being positioned at addresses belonging to the set {1, . . . , F}, where F designates the number of instructions of the program P.

By way of non-limiting illustrative example, a set of instructions referred to as “XJVML” is also defined that serves to illustrate the implementations of the invention.

XJVML describes a simplistic architecture based on the virtual processor JVML0 defined in the document by R. Stata and M. Abadi entitled “A Type System for Java Bytecode Subroutines” published in the reference document SRC Research Report 158 on Jun. 11, 1998 and available at the following electronic address:

http://www.research.digital.com/SRC/

The architecture on which XJVML operates is similar to the computation model known to the person skilled in the art as being the von Neumann computation model, except that it does not contain any program memory. The architecture of XJVML includes:
a volatile memory referred to as the “RAM”;
a non-volatile memory referred to as the “NVM”;
a random number generator referred to as the “RNG”;
an operand stack referred to as the “ST”; and
a communications port (also referred to as an “input/output port”) referred to as “IO”.

The XJVML set of instructions is defined by the following instructions, where x denotes an immediate data item, L is the address of an instruction with 1≦L≦F, and F is the number of instructions of the program in question:
The “inc” instruction increments the data on the top of the stack. The “pop” instruction pops off (removes) the stack element at the top of the stack: the word “unstack” is also used below. The “push0” instruction adds the constant 0 data above the element that is at the top of the stack: the word “stack” is also used below.
The “load x” instruction stacks the data at the address x in the RAM. The “store x” instruction unstacks the data at the top of the stack and copies it back to the address x in the RAM. The “load IO” instruction captures the data presented at the communications port and stacks it while the “store IO” instruction unstacks the top data of the stack and copies it back to the IO port. The “load RNG” instruction generates a random number and stacks it. The “store RNG” instruction does not exist.
The “if L” instruction observes the data at the top of the stack and initializes the program counter to L if that data is not zero.
The “halt” instruction halts execution of the program.
The “getstatic x” instruction stacks the data stored in the NVM at the address x and the “putstatic x” unstacks the top data of the stack and stores it in the non-volatile memory at the address x.
The “xor” instruction unstacks the top two items of data of the stack, computes the XOR (EXCLUSIVE OR) of said items of data, and stacks the result. The effect of the “dec” instruction is exactly the opposite to the effect of the “inc” instruction, i.e. the top item of data is decremented by 1. The “mul” instruction unstacks the top two items of data, multiplies them, and stacks the two items of data representing the result in the form of two words, one of which is the more significant, and the other is the less significant. The “goto L” instruction is a mere jump to the program address L. Finally, the “div” instruction unstacks the top two items of data, divides the lower of said two items of data (the numerator) by the highest item of data in the stack (the denominator), and stacks the item of data resulting from evaluation of the quotient. It should be noted that if, for the “div” instruction, the denominator is zero, an exception is executed, and the program counter is reinitialized to the address of the start of the exception, which address is referred to as “AdExcDivb” below. This exception is referred to as the “division by zero” exception.

The dynamic semantics of the set of instructions are shown diagrammatically in FIG. 1 (it should be noted that there is no rule for the “halt” instruction. In FIG. 1, “undef” designates the item of data by default of a cell of the memory.

It is implicit that the instructions that use the stack cause an interruption if the stack is empty, i.e., by denoting by “s” the number of elements in the stack, if s=0, or indeed if the stack does not contain enough items of data, e.g. when executing an “xor” instruction when s=1.

It is recalled that the term “XμP” designates the device subjected to the method of the invention, i.e. an electronic device that has no program memory, and it is also recalled that the term “XT” designates the “Externalized Terminal”, i.e. the terminal that communicates with the XμP and contains the program P that the XμP executes.

It is also recalled that the program P inserted into each terminal XT (which, it is recalled, is not secure and possibly malevolent) is in the form of a succession of instructions:

1: INS₁

2: INS₂

3 . . .

F: INS_{F}

The principle of the interchange between the XμP and the XT is very simple: when the execution starts, the XμP initializes to 1 its program counter referenced below by the variable i, and requests the instruction of address i from the XT. The XμP executes INSᵢ, thereby updating its internal state and therefore determining the new value of the program counter. The program counter i and the INSᵢ address coincide during execution of the program. Thus, during execution of the program, i designates both the address and the program counter. This method is repeated so long as the end-of-program instruction is not reached.

By way of illustration, the naïve protocol (simple and not secure) for interchange between the XT and the XμP is written as shown in FIG. 2 (it being recalled that executing INSᵢ updates i).

As appears clearly, this simple method is open to numerous attacks. Typically, an attacker can discover a secret key stored in the memory of XμP by means of the following XJVML program:

1 getstatic 1

2 store IO

3 getstatic 2

4 store IO

5 getstatic 3

6 store IO

:

:

:

An attacker could also, for example, modify the amount of an electronic purse in his or her favor.

We thus propose various implementations for authenticating the program P that is transmitted to the XμP.

Generally, the invention relates to a method of making an electronic portable object XμP secure, which object is executing a program P supplied by a non-secure other electronic object XT, said method being characterized in that it uses:
a secret-key protocol;
an ephemeral secret key K;
a MAC function μₖ;
a hash function HASH₁ defined by a compression function H₁ and a constant IV₁;
a hash function HASH₂ defined by a compression function H₂ and a constant IV₂; and
a program identifier ID stored in the electronic object XμP and corresponding to hashing of P.

In a first part of the invention, the method of making an electronic portable object secure is characterized in that the program P is supplied in the form of a succession of F instructions, F thus denoting the number of instructions of said program P.

In said first part of the invention, the value of ID, which corresponds to hashing of the program P, is computed by hashing the instructions one-by-one in increasing order of address.

More precisely, the first part of the invention is characterized in that said protocol comprises the following stages:

a) an initialization stage during which the XμP generates an ephemeral key K, then receives from the XT the set of programs P, the number of instructions F and its identifier ID, computes the hash h of said program P with the HASH₁ function, by using the compression function H₁ and the constant IV₁, and finally generates signatures σᵢ, by means of the μ_{K} function and of the key K, which signatures σᵢ it transmits to the XT;

b) an execution phase during which the XμP checks that h and ID are equal, also verifies that ID is stored in its non-volatile memory, and then requests, one after the other, the instructions of P so as to execute them, and, for some of them, performs a sub-stage of verification that consists in requesting a signature σ, constructed on the basis of the signatures σᵢ generated during the initialization stage and by means of the HASH₂ function, and in verifying said signature σ;

c) a reaction stage that takes place whenever a signature σ is not valid, and that consists, for the XμP, in taking the necessary measures against the fraudulent XT.

This first part of the invention can be implemented in various ways, referred to as the “first”, “second”, and “third” implementations of the invention.

In the first implementation, the method of making an electronic portable object secure is characterized in that the sub-stage of verification in the execution stage is verification of the signature τ taking place prior to execution of each instruction.

More precisely, the first implementation is characterized in that the execution stage comprises the following sub-stages:

b-1) the XμP requests an instruction from the XT;

b-2) the XμP requests a signature σ constructed on the basis of the signatures σᵢ generated during the initialization stage and by means of the HASH₂ function, and, in the event that said signature σ is not valid, executes the reaction stage; and

b-3) the XμP executes the instruction and returns to the sub-stage b-1.

Thus, preferably, the first implementation of the method of the invention for making an electronic portable object secure is characterized in that it uses a secret-key protocol comprising the following steps:

−2. the XμP generates a random session key K, requests from the XT the identifier ID of the program and the number of instructions F it contains, and initializes h←IV₁;

−1 for i←1 to F

(a) the XμP requests from the XT the instruction number i;

(b) the XT sends the INSᵢ instruction to the XμP;

(c) the XμP computes the signature σ_{i←μ}_{K}(ID, i, INSᵢ) and updates h←H₁(h, INSᵢ);

(d) the XμP sends σᵢ to the XT (no copy of σᵢ is kept in the XμP); and

(e) the XT records σᵢ;

0. the XμP verifies that h=ID, that ID is present in the non-volatile memory (in the event of failure, go to step 7), and initializes i←1;

1. the XμP initializes ν←IV₂;

2. the XT initializes σ←IV₂;

3. the XμP requests the instruction number i from the XT;

4. the XT

(a) updates σ←H₂(σ,σᵢ);

(b) sends INSᵢ to XμP;

5. The XμP updates ν←H₂(ν, μ_{K}(ID, i, INSᵢ));

6. The XμP

(a) requests σ from the XT and verifies that σ=ν; in the event of failure, go to step 7;

(b) executes INSᵢ

(c) returns to step 1;

7. The XμP knows that the program supplied is a non-authentic program, and thus takes all of the necessary defensive protection measures.

In the preceding paragraph IV₁ and IV₂ designate the initial vectors of the hash functions HASH₁ and HASH₂; i is still the value representing the program counter; σᵢ designates the signature of the INSᵢ instruction. It is recalled that execution of INSᵢ modifies the value of i. The letters h, ν and σ designate variables of the protocol whose use is explained below.

The above protocol comprises various different steps. We have used (−2) and (−1) to reference the “negative” steps that take place before execution of the program P, and (0) to (7) to reference the “positive” steps that take place during execution of the program P.

In step (−2), the XμP randomly generates an ephemeral key K. This random generation can take place using a hardware random number generator, or using some other means. In addition, the value h is initialized to the initial value IVᵢ.

The step (−1) is a loop to the program addresses i. It is made up of sub-steps.
in sub-step (−1.a), the XμP requests the address instruction i from the XT;
in the sub-step (−1.b), the XT sends the requested instruction to the XμP;
in the sub-step (−1.c), the XμP computes the symmetrical signature (also referred to as the “signature” or the “MAC”) σᵢ of the instruction; in addition, the XμP accumulates the hashing of the program in the value h by means of the compression function H₁;
in the sub-step (−1.d), the MAC σᵢ is sent by the XμP to the XT; and
finally, in the sub-step (−1.e), the MAC σᵢ received from the XμP is stored by the XT.

The steps taking place during execution of the program P then take place.

In step (0), the XμP verifies that the final value of h (computed during the loop of step (−1)) is equal to the value ID, stored in its non-volatile memory. By means of the non-collision property of the hash function, the XμP is thus sure that the program for which it has computed the sequence of the MACs σᵢ during the negative steps is indeed authorized for execution. In addition, during the step (0), the program counter i is initialized to 1. If the value of h differs from the value of ID, the program sent is not authentic, and the section (7) is executed: the XμP then takes the appropriate measures against the presumed aggression (e.g. the XμP deletes its memory).

The steps (1), (2), (3), (4), (5), (6) are then repeated a certain number of times, until the final instruction is executed. This loop method is explained below.

In step (1), the XμP initializes the variable ν to IV₂.

In step (2), the XT initializes the variable σ to IV₂.

In step (3), the XμP requests the instruction of address i from the XT.

In step (4), the XT re-updates the variable σ and sends the requested instruction to the XμP.

In step (5), the XμP re-updates the variable ν.

Step (6) is the critical step for security. The sub-steps (6.a), (6.b) and (6.c) are performed. The sub-step (6a.a) is a sub-step during which the XμP requests to the XT to send it the collective signature σ. The Xμ4P then makes a comparison with the value ν that it computed previously. If the values differ, the program P received is not authentic, and the step (7) is then executed: the XμP then takes the appropriate measures against the aggression. If the values are equal, the XμP continues the execution of the protocol by executing the received instruction and by returning to the step (1).

Thus, in the negative steps, the XμP itself signs the program that is sent to it by means of an ephemeral key K, while verifying that said key is correct by comparing the hashing of the program that is sent to it with the identifier that it contains in its memory (ID). In the positive steps, it then merely remains, for each instruction, to compare the signature supplied by the XT with the signature that the XμP re-computes.

It is thus impossible for the XT to send a foreign instruction: it is not possible for it to have a program signed in step (−1) other than the program of the identifier ID without being detected at step (0), due to the non-collision property of the hash function. Therefore, during execution of the positive steps, the XT can but send instructions that are signed by the XμP during execution of the negative steps, i.e. the instructions that do indeed correspond to the program; otherwise, if the XT tries to send different instructions, it cannot send the correct signature during the verification because it cannot compute the signatures by itself due to the fact that it does not know the signature key K.

This solution is secure, but can be improved.

The first implementation can undergo an improvement which is constituted by a second implementation of dynamic verification of the program P which is sent to the XμP. In the second implementation, only certain instructions trigger a verification of the collective signature σ.

For this purpose, a list is made of the instructions that issue information to the outside of the XμP that relates to the items of data used while they are being executed in the XμP (e.g. the instructions for controlling the input-output port). Then, the instructions that might modify the state of the non-volatile memory of the device are added to said list of instructions. All of said instructions are referred to as being “critical for security” in the following sections and the entire set of instructions that are critical for security are referenced S.

Returning to the illustrative example of the elementary language XJVML, a list is made of the instructions that, for certain values of their inputs, have special behavior that is recognizable from the outside. Such an instruction is then referred to as being “traceable” if the value of the data used by the instruction can influence the value of a physically observable variable (e.g. the program counter). The “if L” and “div” instructions are thus traceable due to their influence on the program counter (it being possible for the “div” instruction to cause an interruption in the event of the denominator being zero). The reverse of this concept is the concept of “indistinguishability in terms of data” that characterizes instructions for which the data used has no influence on the environmental variables. For example, execution of the “xor” instruction does not reveal any information on the two elements on the top of the stack that could be observed from outside the XμP.

Since execution of traceable instructions can reveal information about internal values of the program, such instructions are, by definition, critical for security, and are thus included in S. For example, in the XJVML illustrative set of instructions, only the “if L” and “div” instructions are traceable, and the set S is thus defined as below:

S={putstatic x, store IO, if L, div}

The “store IO” instruction is in S because it could trigger emission of an electrical signal to the outside (via the input-output port). The “putstatic x” instruction is also in S because it can modify the non-volatile memory.

Thus, for a given set of instructions, the classification of the instructions making it possible to define S leads us thus to the second implementation of the invention as described in the following section.

In the second implementation of the invention, the method of making an electronic portable object secure is characterized in that the sub-stage of verification in the execution stage is verification of the signature σ taking place prior to execution of the instruction, if said instruction is an instruction that is critical for security.

More precisely, in the second implementation, the method of making an electronic portable object secure is characterized in that the execution stage comprises the following sub-stages:

b-1) the XμP requests an instruction from the XT;

b-2) if said instruction is critical for security, the XμP requests a signature σ constructed on the basis of the signatures σᵢ generated during the initialization stage and by means of the HASH₂ function, and, in the event that said signature σ is not valid, executes the reaction stage; and

b-3) the XμP executes the instruction and returns to the sub-stage b-1.

Preferably, also in the second implementation, the method of making an electronic portable object secure is characterized in that it uses a set S of instructions that are critical for security, and in that the protocol comprises the following steps:

−2. the XμP generates a random session key K, requests from the XT the identifier ID of the program and the number of instructions F it contains, and initializes h←IV₁;

−1 for i←1 to F

(a) the XμP requests from the XT the instruction number i;

(b) the XT sends the INSᵢ instruction to the XμP;

(c) the XμP computes the signature σᵢ←μ_{K}(ID, i, INSᵢ) and updates h←H₁(h, INSᵢ);

(d) the XμP sends σᵢ to the XT (no copy of σᵢ is kept in the XμP); and

(e) the XT records σᵢ;

0. the XμP verifies that h=ID, that ID is present in the non-volatile memory (in the event of failure, go to step 8), and initializes i←1;

1. the XμP initializes ν←IV₂;

2. the XT initializes σ←IV₂;

3. the XμP requests the instruction number i from the XT;

4. the XT

(a) updates σ←H₂(σ,σᵢ);

(b) sends INSᵢ to XμP;

5. The XμP updates ν←H₂(ν,μ_{K}(ID, i, INSᵢ));

6. If INSᵢεS, the XμP
(a) requests σ from the XT and verifies that σ=ν; in the event of failure, go to step 8;

(b) executes INSᵢ;

(c) returns to step 1;

7. Otherwise, the XμP

(a) executes INSᵢ;

(b) returns to step 3;

8. The XμP knows that the program supplied is a non-authentic program, and thus takes all of the necessary defensive protection measures.

In the preceding paragraph IV₁ and IV₂ designate the initial vectors of the hash functions HASH₁ and HASH₂; i is still the value representing the program counter; σᵢ designates the signature of the INSᵢ instruction. It is recalled that execution of INSᵢ modifies the value of i. The letters h, ν and σ designate variables of the protocol whose use is explained below.

The protocol comprises various different steps. We have used (−2) and (−1) to reference the “negative” steps that take place before execution of the program P, and (0) to (7) to reference the “positive” steps that take place during execution of the program P.

In step (−2), the XμP randomly generates an ephemeral key K. This random generation can take place using a hardware random number generator, or using some other means. In addition, the value h is initialized to the initial value IV.

The step (−1) is a loop to the program addresses i. It is made up of sub-steps.
in sub-step (−1.a), the XμP requests the address instruction i from the XT;
in the sub-step (−1.b), the XT sends the requested instruction to the XμP;
in the sub-step (−1.c), the XμP computes the symmetrical signature (also referred to as the “signature” or the “MAC”) σᵢ of the instruction; in addition, the XμP accumulates the hashing of the program in the value h by means of the compression function H₁;
in the sub-step (−1.d), the MAC σᵢ is sent by the XμP to the XT; and
finally, in the sub-step (−1.e), the MAC σᵢ received from the XμP is stored by the XT.

The steps taking place during execution of the program P then take place.

In step (0), the XμP verifies that the final value of h (computed during the loop of step (−1)) is equal to the identifier ID, stored in its non-volatile memory. By means of the non-collision property of the hash function, the XμP is thus sure that the program for which it has computed the sequence of the MACs σᵢ during the negative steps is indeed authorized for execution. In addition, during the step (0), the program counter i is initialized to 1. If the value of h differs from the value of ID, the program sent is not authentic, and the section (8) is executed: the XμP then takes the appropriate measures against the presumed aggression (e.g. the XμP deletes its memory).

The steps (1), (2), (3), (4), (5), (6) (7) are then repeated a certain number of times, until the final instruction is executed. This loop method is explained below.

In step (1), the XμP initializes the variable ν to IV₂.

In step (2), the XT initializes the variable a to IV_{2.}

In step (3), the XμP requests the instruction of address i from the XT.

In step (4), the XT re-updates the variable σ and sends the requested instruction to the XμP.

In step (5), the XμP re-updates the variable ν.

Step (6) is the critical step for security. It begins firstly with a test.
If the received instruction INSᵢ is in the set S of instructions that are critical for security, the sub-steps (6.a), (6.b) and (6.c) are performed. The sub-step (6a.a) is a sub-step during which the XμP requests to the XT to send it the collective signature σ. The XμP then makes a comparison with the value ν that it computed previously. If the values differ, the program P received is not authentic, and the step (8) is then executed: the XμP then takes the appropriate measures against the aggression (e.g. the XμP re-initializes its memory). If the values are equal, the XμP continues the execution of the protocol by executing the received instruction and by returning to the step (1).
If the received instruction INSᵢ is not in the set S of instructions that are critical for security, step (7) is executed: the XμP executes merely INSᵢ and continues to execute the method by returning to step (3).

Thus, in the negative steps, the XμP itself signs the program that is sent to it (once again by means of an ephemeral key K), while verifying that said key is authentic by comparing the hashing of the program that is sent to it with the program identifier that it contains in its memory (ID). In the positive steps, the method makes it possible to verify collectively, at the appropriate times (i.e. for all of the instructions that are critical for security, and that are listed in the set S) that the signatures supplied by the XT are identical to the signatures that the XμP had computed in the negative steps.

Like in the first implementation, it is impossible for the XT to send an instruction that is foreign to the program: it is not possible for it to have a program signed in step (−1) other than the program of the identifier ID without being detected at step (0), due to the non-collision property of the hash function. Therefore, during execution of the positive steps, the XT can but send instructions that are signed by the XμP during execution of the negative steps, i.e. the instructions that do indeed correspond to the program; otherwise, if the XT tries to send different instructions, it cannot send the correct signature during the verification because it cannot compute the signatures by itself due to the fact that it does not know the signature key K.

It is however possible to improve the performance of the invention further by means of a third implementation of the invention.

In the third implementation of the invention, a security level is associated with each of the items of data manipulated by the XμP. It makes it possible to distinguish a secret item of data (e.g. a cryptographic key stored in the non-volatile memory) from a public item of data (that is known or that can be re-computed on the basis of known data). For reasons of conciseness, the reference Φ is used to denote the set of security levels defined at a given instant by execution of a given program. There exist various ways of defining a level of security on an item of computation data, but it can be assumed generally that the set Φ of security levels is initialized to certain specific values prior to execution of the program P, and that executing an instruction of P can modify Φ in compliance with rules that are chosen arbitrarily by the designer of the device.

By way of non-limiting and illustrative example, a description follows of a particular implementation of said method as applied to the above-described XJVML architecture.

The security level is implemented in the form of an information bit φ using the convention that its value is zero when the item of data in question is public and one when it is secret. More specifically, implementing the method concerns the volatile memory cells (RAM), the non-volatile memory cells (NVM), and the stack cells (ST). Thus, φ(RAM[j]) is used to denote the security bit associated with the memory word RAM[j], φ(NVM[j]) is used to denote the security bit associated with NVM[j], and φ(ST[j]) is used to denote the security bit associated with ST[j]. By convention, the security bits of the NVM cells are non-volatile and positioned at 0 or 1 by the manufacturer of the XμP at the production or customization stage, depending on the nature of the corresponding non-volatile data. The security bits of the RAM are initialized to 0 during resetting of the device. By convenient, φ(IO) is left constant at 0 and φ(RNG) is left constant at 1. Finally, the security bits of the unused stack elements are automatically reset (to 0).

Two elementary rules are also presented whereby the security bit of a new program variable, i.e. of an item of data coming from computation based on preceding data, is established as a function of the security bit of said preceding data.

The first rule is that all of the transfer instructions (“load”, “getstatic”, “store”, and “putstatic”) also transfer the security bit of the transferred variable. The second rule is applied to the arithmetic and logic instructions. It defines each security bit of the output variables of the instruction in question as the logic OR of the security bits of all of the input variables of the instruction. In other words, as soon as a secret item of data is involved in the computation, all of the items of data that follow therefrom are listed as being secret. This rule can in particular, but not exclusively, be easily hard-wired as a simple Boolean OR (referenced V in FIG. 5) for the binary instructions (i.e. with two input arguments). For reasons of clarity, FIG. 5 gives the dynamic semantics of the XJVML instructions on Φ.

Given any set of instructions, and the rules making it possible to define over time the set of security levels Φ for the data used by execution of a program, the method of the invention is associated therewith as described by its second implementation. The principle of the third implementation is based on the fact that collective verification of the instructions issued by the XT, hitherto triggered by detection of an instruction that is critical for security, can be spared whenever said instruction uses, for example, only items of data that are listed as being public. A MAC verification is not necessarily called for in that case since the danger inherent to execution of a critical instruction is removed by the fact that said instruction can supply information only on data that is previously known, or can modify such data.

In conclusion, Alert(INS, Φ) is used to denote the Boolean function (i.e. returning TRUE or FALSE) which determines whether or not the execution of the critical instruction INS causes a verification to take place when the security level of the input data that the instruction is manipulating is given by Φ.

In our example of implementation in the context of XJVML language, the Alert function can be defined in various different ways, as shown in FIGS. 3 and 4.

Thus, a third implementation of the invention is defined, characterized in that the sub-stage of verification in the execution stage is verification of the signature σ taking place prior to execution of the instruction if said instruction is an instruction that is critical for security, and if at least one of the items of data used for said instruction is a secret item of data.

More precisely, in the third implementation, the method of making an electronic portable object secure is characterized in that it uses a variable Φ defining the set of security levels defined at a given instant by execution of a given program P, and in that the execution stage comprises the following sub-stages:

b-1) the XμP requests an instruction from the XT;

b-2) if said instruction is critical for security and if at least one of the items of data used by the instruction is secret, then the XμP requests a signature σ constructed on the basis of the signatures σᵢ generated during the initialization stage and by means of the HASH₂ function, and, in the event that said signature σ is not valid, executes the reaction stage; and

b-3) the XμP executes the instruction, updates the security level (secret or non-secret data) of each of the items of data coming from the execution, and returns to the sub-stage b-1.

When the Alert Boolean function is used, the third implementation is characterized in that it uses a variable Φ defining the set of security levels defined at a given instant by execution of a given program P, and in that the execution stage comprises the following sub-stages:

b-1) the XμP requests an instruction from the XT;

b-2) if said instruction is critical for security and if the Alert Boolean function determined on the basis of the security level of the data used by the instruction and by the nature of the instruction itself is evaluated as TRUE, then the XμP requests a signature σ constructed on the basis of the signatures σᵢ generated during the initialization stage and by means of the HASH₂ function, and, in the event that said signature σ is not valid, executes the reaction stage; and

b-3) the XμP executes the instruction, updates the security level (secret or non-secret data) of each of the items of data coming from the execution, and returns to the sub-stage b-1.

Preferably, said third implementation is characterized in that it uses a set of instructions that are critical for security S and in that the protocol comprises the following steps:

−2. the XμP generates a random session key K, requests from the XT the identifier ID of the program and the number of instructions F it contains, and initializes h←IV₁;

−1 for i←1 to F

(a) the XμP requests from the XT the instruction number i;

(b) the XT sends the INSᵢ instruction to the XμP;

(c) the XμP computes the signature σᵢ←μ_{K}(ID, i, INSᵢ) and updates h←H₁(h, INSᵢ);

(d) the XμP sends σᵢ to the XT (no copy of σᵢ is kept in the XμP); and

(e) the XT records σᵢ;

0. the XμP verifies that h=ID, that ID is present in the non-volatile memory (in the event of failure, go to step 8), and initializes i←1;

1. the XμP initializes ν←IV₂;

2. the XT initializes σ←IV₂;

3. the XμP requests the instruction number i from the XT;

4. the XT

(a) updates σ←H₂(σ,σᵢ);

(b) sends INSᵢ to XμP;

5. The XμP updates ν←H₂(ν,μ_{K}(ID, i ,INSᵢ));

6. If INSᵢεS and Alert (INSᵢ, Φ)=TRUE, the XμP

(a) requests σ from the XT and verifies that σ=ν; in the event of failure, go to step 8;

(b) executes INSᵢ;

(c) updates Φ;

(d) returns to step 1;

7. Otherwise, the XμP

(a) executes INSᵢ;

(b) updates Φ;

(c) returns to step 3;

8. The XμP knows that the program supplied is a non-authentic program, and thus takes all of the necessary defensive protection measures.

Thus, unlike the protocol described in the second implementation of the invention, a verification of the collective signature in step 6 is performed only when the Alert function is evaluated as being TRUE immediately before the critical instruction is performed.

As a function of implementation of said function, the designer of the architecture thus obtains means of verifying the program as a function of context, i.e. by avoiding, in the protocol, triggering a verification considered as being unnecessary in view of the security level of the data at stake.

In a second part of the invention, the program is authenticated in groups of instructions, and no longer in single instructions. The instructions can be grouped together in the form of small blocks referred to as “sections” which make it possible to limit the number of signatures generated and verified by the XμP.

Using the conventional definition of the documents “Advanced Compiler Design and Implementation” by S Muchnick, published in 1997, and “Compilers: Principles, Techniques, and Tools” by A. Aho, R. Sethi, and J. Ullman, published in 1986, the term “basic block” is used to designate a sequential and ordered succession of instructions that can be executed only by executing the first instruction and the last instruction. The person skilled in the art usually describes the set of basic blocks of a program P in the form of a “Control Flow Graph” (CFG(P)) computed by known control flow analysis means (explained, in particular in the documents “Identifying Loops in Almost Linear Time” by G. Ramalingam, published in 1999, and “Advanced Compiler Design and Implementation” by S. Muchnick, published in 1997). In such a graph, the nodes are identified in the basic blocks and the edges symbolize the control flow dependencies.

The presence of a B₀->B₁ edge in the graph (it is then said that B₁ is a son of B₀ and that Bo is a father of B₁) means that the last instruction in the block B₀ can transfer control of the program to the first instruction of B₁.

When B₀->B₁, B₀=>B₁ means that B₀ has no son other than B₁ (but B₁ can have other fathers than B₀). A concept that is slightly different from the concept of basic blocks and that is referred to as the “program section” concept is described below.

Strictly, a program section is a maximum succession of basic blocks B₀=>B₁=>B₂=> . . . =>B_{Z} such that no end-of-program instruction (“halt” in XJVML) or any instruction from S (critical instruction) appears in the blocks except possibly as a last instruction of B_{z}. The section is then denoted by s=<B₀, B₁, . . . , B₂>. In a program section, as in basic blocks, control flow is deterministic, i.e. independent of the values that the program variables might take during execution.

It is known that basic blocks of a program can be computed in almost linear time in the number of instructions of said program (“Identifying Loops in Almost Linear Time” by G. Ramalingam, published in 1999), and the person skilled in the art can easily see that the algorithms making it possible to compute CFG(P) on the basis of P can be modified in simple manner so as to compute, in equally high-performance manner, the entire set of the sections of the program P. Thus, the sections of P can be computed easily during compilation of P.

The second part of the invention can be implemented in fourth, fifth, and sixth implementations of the invention that are described below. In these implementations, the symmetrical signatures generated by the XμP authenticate sections rather than individual instructions of the program.

Unlike the first three implementations of the first part of the invention, in which the program is supplied in the form of a succession of instructions, said fourth, fifth, and sixth implementations of the invention are methods of making an electronic portable object secure that are characterized in that the program P is supplied in the form of a succession of sections or blocks of instructions, G denoting the number of sections of said program P, and in that it uses a third hash function, referred to as HASH₃, defined by a compression function H₃ and a constant IV₃.

In said second part of the invention, the value of ID, which corresponds to the hashing of the program P, is computed by hashing the sections one-by-one in increasing order of the addresses of said sections, and then finally by hashing the hashes of the sections in increasing order of the starting addresses of the sections.

More precisely, the second part of the invention is characterized in that said protocol includes the following stages:

a) an initialization stage during which the XμP generates an ephemeral key K, then receives from the XT the entire set of the program P, its number of sections G and its identifier ID, computes the hash h of said program P with the HASH₁ function, by using the compression function H₁ and the constant IV₁, and with the HASH₃ function, by using the compression function H₃ and the constant IV₃ and finally generates signatures σⱼ, by means of the AK function and of the key K, which signatures σⱼ it transmits to the XT;

b) an execution phase during which the XμP checks that h and ID are equal, also verifies that ID is stored in its non-volatile memory, and then requests, one after the other, the sections of P so as to execute them, and, for some of them, performs a sub-stage of verification that said sections comply, and then finally, for the final instruction of certain sections, performs a sub-stage of verification that consists in requesting a signature σ, constructed on the basis of the signatures σᵢ generated during the initialization stage and by means of the HASH₂ function, and in verifying said signature;

c) a reaction stage that takes place whenever a signature σ is not valid or whenever a section does not comply, and that consists, for the XμP, in taking the necessary measures against the fraudulent XT.

More precisely, the sub-stage of verification that a given section complies consists in verifying that no instruction of that section, except possibly for the last instruction, is an instruction that is critical for security.

This second part of the invention can be implemented in various ways, referred to as the “fourth”, “fifth”, and “sixth” implementations of the invention.

The fourth implementation is characterized in that the sub-stage of verification in the execution stage is verification of the signature ν taking place prior to execution of the final instruction of each section.

More precisely, the fourth implementation is characterized in that the execution stage comprises the following sub-stages:

b-1) the XμP requests a section from the XT;

b-2) for each non-final instruction of the requested section, the XμP verifies whether said instruction is critical, and, if it is, performs the reaction phase, and, otherwise, executes said instruction and goes to the next instruction;

b-3) for the final instruction of the requested section:

b-31) the XμP requests a signature C constructed on the basis of the signatures σⱼ generated during the initialization stage and by means of the HASH₂ function, and, in the event that said signature σ is not valid, executes the reaction stage; and

b-32) the XμP executes the instruction;

b-4) the XμP then returns to the sub-stage b-1.

Preferably, the fourth implementation of the invention is characterized in that it uses a secret-key protocol comprising the following steps:

−2. the XμP generates a random session key K, requests from the XT the identifier ID of the program and the number of sections G it contains, and initializes h←IV₁;

−1 for j←1 to G

(a) the XμP requests from the XT the section number j, the number t of instructions in said section, and initializes g IV₃;

(b) for i←1 to t, the XT sends the INSᵢ instruction to the XμP which updates g←H₃(g, INSᵢ);

(c) the XμP computes the signature σⱼ←μ_{K}(ID, j, g) of the section and updates h←H₁(h, g);

(d) the XμP sends σⱼ to the XT (no copy of σᵢ is kept in the XμP); and

(e) the XT records σᵢ;

0. the XμP verifies that h=ID, that ID is present in the non-volatile memory (in the event of failure, go to step 9), and initializes j←1;

1. the XμP initializes ν←IV₂;

2. the XT initializes σ←IV₂;

3. the XμP requests from the XT the section number j, and the number t of instruction that makes up the section, and initializes g←IV₃ and i←1;

4. the XT updates σ←H₂(σ,σᵢ) and initializes i←1;

5 the XT sends INSᵢ to the XμP and increments i←i+1;

6. The XμP updates g←H₃(g, INSᵢ);

7. If i<t, then the XμP
(a) tests whether INSᵢεS, and if so, go to step 9;

(b) executes INSᵢ

(c) returns to step 5;

8. If i=t, then the XμP

(a) updates ν←H₂(ν, μ_{K} (ID, j, g));

(b) requests a from XT and verifies that σ=ν; in the event of failure, go to step 9;

(c) executes INSᵢ

(d) returns to step 1; and

9. The XμP knows that the program supplied is a non-authentic program, and thus takes all of the necessary defensive protection measures.

In the preceding paragraph, and below (for the fifth and sixth implementations), the signature of a section Sj whose first instruction has the address j and which is made up of the instructions INS₁ . . . , INSₖ can be defined, for example, by:

σⱼ=μ(ID, j, g)

where g designates g=HASH₃(INS₁, . . . , INSₖ)

HASH₃ in this example being a hash function defined by a compression function H₃ and an initialization vector IV₃ as in the state of the art. Using the conventional definition of hashing by iteration is essential to the fourth, fifth, and sixth implementations.

The fourth implementation is also made up of negative steps and positive steps. Operation of it is explained briefly, since said operation is very similar to operation of the first implementations. In step (−2), a random key K is generated, and the identifier ID and the number of sections G are requested. Then h is initialized to IVᵢ. In step (−1), the program P is signed by means of the key K and of the MAC function μK. In this example, the signatures are signatures per section. The signatures σᵢ are generated by the XμP and then sent to the XT, which stores them. In step (0) the XμP verifies that the program is correct by verifying that the computed hash is identical to ID, and that ID is present in its non-volatile memory. The steps (1) and (2) are initialization steps for the XμP and the XT. In step (3), the XμP requests the number of instructions t of the current section from the XT, and initializes g to IV₃. The XT re-updates the variable σ in step (4), and initializes i to 1. In step (5), the current instruction of the current section is sent to the XμP and i is incremented. The XμP then re-updates g, a variable that it uses to accumulate the hashing of the current section. Step (6) is a step of verification of the compliance of the section: the XμP verifies, in step (6), that all of the non-final instructions are non-critical. It also executes these instructions. The step (7) is the step that takes place for the final instruction of the section: the XμP then requests a signature and verifies the authenticity thereof. In the event of success, the instruction is executed, and the method starts again from step 1. Finally, at any time, if a section does not comply, or if a signature is false, step (9), which is the step of the reaction step, is executed: the XμP then takes the necessary protective measures.

Unlike the preceding implementations, each section can, at the most, cause one MAC verification.

It is recalled that an instruction that is critical for security may only be in the position of last instruction of a section. By definition, the last instruction INSₖ of a section is:
either an instruction of S; in which case, execution of it can or cannot trigger a signature verification, using the Alert (INS, Φ) security policy;
or the end-of-program instruction (“halt” in XJVML), which interrupts the execution.

By going back to the ideas of the second and third implementations, but as applied to a given program P in the form of sections, the fifth and sixth implementations of the invention can be derived.

The fifth implementation of the invention is a method of making an electronic portable object secure that is of the second part of the invention type (i.e. with a given program P in the form of sections), characterized in that the sub-stage of verification in the execution stage is verification of the signature σ taking place prior to execution of the final instruction of each section, if said instruction is an instruction that is critical for security.

More precisely, the fifth implementation is characterized in that the execution stage comprises the following sub-stages:

b-1) the XμP requests an instruction from the XT;

b-2) for each non-final instruction of the requested section, the XμP verifies whether said instruction is critical, in which case it performs the reaction stage, and otherwise it executes said instruction and goes on to the next instruction;

b-3) for the final instruction of the requested section:

b-31) if the instruction is critical for security, the XμP requests a signature σ constructed on the basis of the signatures σⱼ generated during the initialization stage and by means of the HASH₂ function, and, in the event that said signature σ is not valid, executes the reaction stage; and

b-32) the XμP executes the instruction; and

b-4) the XμP then returns to the sub-stage b-1.

Preferably, the fifth implementation is characterized in that it uses a set S of instructions that are critical for security, and in that the protocol comprises the following steps:

−2. the XμP generates a random session key K, requests from the XT the identifier ID of the program and the number of sections G it contains, and initializes h←IV₁;

−1 for j←1 to G

(a) the XμP requests from the XT the section number j, the number t of instructions in said section, and initializes g←IV₃;

(b) for i←1 to t, the XT sends the INSᵢ instruction to the XμP which updates g←H₃(g, INSᵢ);

(c) the XμP computes the signature νⱼ←μ_{K}(ID, j, g) of the section and updates h←H₁(h, g);

(d) the XμP sends σⱼ to the XT (no copy of σⱼ is kept in the XμP); and

(e) the XT records σⱼ;

0. the XμP verifies that h=ID, that ID is present in the non-volatile memory (in the event of failure, go to step 10), and initializes j←1;

1. the XμP initializes ν←IV₂;

2. the XT initializes σ←IV₂;

3. the XμP requests from the XT the section number j, and the number t of instructions that make up the section, and initializes g←IV₃ and i←1;

4. the XT updates σ←H₂(σ,σⱼ) and initializes i←1;

5 the XT sends INSᵢ to the XμP and increments i←i+1;

6. The XμP updates g←H₃(g, INSᵢ);

7. If i<t, then the XμP

(a) tests whether INSᵢεS, and if so go to step 10;

(b) executes INSᵢ

(c) returns to step 5;

8. If i=t and INSᵢεS, then the XμP

(a) updates ν←H₂(ν, μ_{K}(ID, j, g));

(b) requests σ from XT and verifies that σ=ν; in the event of failure, go to step 10;

(c) executes INSᵢ

(d) returns to step 1;

9. If i=t and INSᵢεS, then the XμP

(a) updates ν←H₂(ν, μ_{K}(ID, j, g));

(b) executes INSᵢ

(c) returns to step 1;

10. The XμP knows that the program supplied is a non-authentic program, and thus takes all of the necessary defensive protection measures.

The fifth implementation of the invention is very similar to the fourth implementation, and only those stages which differ from said fourth implementation, i.e. stage 8 and 9, are explained below. In the fourth implementation, all of the final instructions of the sections undergo signature verification. In the fifth implementation, in step (8), the final instruction is tested: if it is critical, a signature is requested.

Conversely, if the final instruction is not critical, then, in step (9), the instruction is executed without requesting signature, and the protocol is continued by returning to step 3.

As can be seen, the advantage is considerable: only certain final instructions undergo signature verification, and thus the protocol is correspondingly faster.

However, it is still possible to make a final improvement to the protocol, which improvement is the subject of the sixth implementation of the invention.

The sixth implementation is a method of making an electronic portable object secure characterized in that the sub-stage of verification in the execution stage is verification of the signature σ taking place prior to execution of the final instruction of each section, if said instruction is an instruction that is critical for security, and if at least one of the items of data used by said instruction is a secret item of data.

More precisely, the sixth implementation of the invention is a method of making an electronic portable object secure that is characterized in that it uses a variable Φ defining the set of security levels defined at a given instant by execution of a given program, and in that the execution stage comprises the following sub-stages:

b-1) the XμP requests an instruction from the XT;

b-2) for each non-final instruction of the requested section, the XμP verifies whether said instruction is critical, in which case it performs the reaction stage, and otherwise it executes said instruction and goes on to the next instruction;

b-3) for the final instruction of the requested section:

b-31) if the instruction is critical for security, and if at least one of the items of data used by the instruction is secret, the XμP requests a signature σ constructed on the basis of the signatures σⱼ generated during the initialization stage and by means of the HASH₂ function, and, in the event that said signature σ is not valid, executes the reaction stage; and

b-32) the XμP executes the instruction;

b-33) the XμP updates the security level (secret data or non-secret data) of each of the items of data coming from the execution; and

b-4) the XμP then returns to the sub-stage b-1.

Another way of implementing the sixth implementation of the invention is to use a protocol, characterized in that it uses a variable Φ defining the set of security levels defined at a given instant by execution of a given program, in that it uses an Alert Boolean function and in that the execution stage comprises the following sub-stages:

b-1) the XμP requests an instruction from the XT;

b-2) for each non-final instruction of the requested section, the XμP verifies whether said instruction is critical, in which case it performs the reaction stage, and otherwise it executes said instruction and goes on to the next instruction;

b-3) for the final instruction of the requested section:

b-31) if the instruction is critical for security, and if the Alert Boolean function determined on the basis of the security level of the data used by the instruction and by the nature of the instruction itself is evaluated as being TRUE, the XμP requests a signature σ constructed on the basis of the signatures σⱼ generated during the initialization stage and by means of the HASH₂ function, and, in the event that said signature σ is not valid, executes the reaction stage; and

b-32) the XμP executes the instruction;

b-33) the XμP updates the security level (secret data or non-secret data) of each of the items of data coming from the execution; and

b-4) the XμP then returns to the sub-stage b-1.

Thus, preferably, the sixth implementation is characterized in that it uses a set S of instructions that are critical for security, and in that the protocol comprises the following steps:

−2. the XμP generates a random session key K, requests from the XT the identifier ID of the program and the number of sections G it contains, and initializes h←IV₁;

−1 for j←1 to G

(a) the XμP requests from the XT the section number j, the number t of instructions in said section, and initializes g←IV₃;

(b) for i←1 to t, the XT sends the INSᵢ instruction to the XμP which updates g←H₃(g, INSᵢ);

(c) the XμP computes the signature σⱼ←μ_{K}(ID, j, g) of the section and updates h←H₁(h, g);

(d) the XμP sends σⱼ to the XT (no copy of σⱼ is kept in the XμP); and

(e) the XT records σⱼ;

0. the XμP verifies that h=ID, that ID is present in the non-volatile memory (in the event of failure, go to step 10), and initializes j←1;

1. the XμP initializes νIV₂;

2. the XT initializes σ←IV₂;

3. the XμP requests from the XT the section number j, and the number t of instructions that make up the section, and initializes g←IV₃ and i←1;

4. the XT updates σ←H₂(σ,σⱼ) and initializes i←1;

5 the XT sends INSᵢ to the XμP and increments i←i+1;

6. The XμP updates g←H₃(g, INSᵢ);

7. If i<t, then the XμP

(a) tests whether INSᵢεS, and if so go to step 10;

(b) executes INSᵢ;

(c) updates Φ;

(d) returns to step 5;

8. If i=t and INSᵢ E S and Alert (INSᵢ,Φ)=TRUE), then the XμP

(a) updates ν←H₂ (ν,μ_{K}(ID, j, g));

(b) requests σ from XT and verifies that σ=ν; in the event of failure, go to step 10;

(c) executes INSᵢ;

(d) updates Φ;

(e) returns to step 1;

9. If i=t and INSᵢεS or Alert (INSᵢ,ΦD)=FALSE), then the XμP

(a) updates ν←H₂(ν,μ_{K}(ID, j, g));

(b) executes INSᵢ;

(c) updates Φ;

(d) returns to step 3;

10. The XμP knows that the program supplied is a non-authentic program, and thus takes all of the necessary defensive protection measures.

The difference between the sixth implementation and the fifth implementation is minimal, and is explained as follows: in step (8) a test is made not only to determine whether the final instruction is critical for security, but also to determine whether one of the input items of data of the instruction is secret (this is given by the condition Alert (INSᵢ, Φ)=TRUE). If these two conditions are satisfied, signature verification is triggered, the instruction is then executed, and the protocol starts again from step (1). Conversely, otherwise, the instruction is executed without triggering the signature verification, and the protocol starts again from step (3).

As can be seen by the person skilled in the art, the latter protocol minimizes the number of signatures requested from the XT, while also guaranteeing the security of the XμP.

In the second or third implementations of the first part of the invention, and in the fourth, fifth, or sixth implementations of the second part of the invention, the method is characterized in that at least one of the following types of instruction are critical for security:
the test instructions and/or
the instructions issuing information to the outside via communications means and/or
the instructions modifying the contents of the non-volatile memory and/or
the computation instructions presenting special cases during execution of them, such as the launch of exceptions.

In addition, the third and sixth implementations are preferably characterized in that the Alert Boolean function is evaluated as being TRUE for at least one of the following types of instruction:
the test instructions and/or
the instructions issuing information to the outside via communications means and/or
the instructions modifying the contents of the non-volatile memory and/or
the computation instructions presenting special cases during execution of them, such as the launch of exceptions.

In an even more effective solution, the third and sixth implementations are characterized in that the Alert Boolean function is evaluated as being TRUE for at least one of the following types of instruction, if at least one of the input items of data is secret, and as being FALSE if all of the items of data tested are public:
the test instructions and/or
the instructions issuing information to the outside via communications means and/or
the instructions modifying the contents of the non-volatile memory and/or
the computation instructions presenting special cases during execution of them, such as the launch of exceptions.

For the third and sixth implementations, the set of security levels Φ used during execution of a program P is preferably indicated by the value of a function φ, such that, for any item of data u used by the program, φ(u)=0 designates the fact that u is public and φ(u)=1 designates the fact that u is private, and such that, for any item of data v resulting from execution of an instruction of the program P, φ(v)=1 if at least one of the items of input data of the instruction is private, and, otherwise φ(v)=0.

More precisely, the values of the function φ are computed by means of hardware implementation of a “Logic OR” function implemented on the values of the φ function for the input data of the instructions.

Finally, with concern for simplicity and practicality, the hash functions HASH₁, HASH₂, and HASH₃ can be identical.

The present invention also applies to an electronic object characterized in that it implements any of the implementations of the invention as described above.

1. A method of making instructions of an electronic portable object XμP secure, which object is executing a program P supplied by a non-secure other electronic object XT in the form of a succession of F instructions, F thus denoting the number of instructions of said program P, said method using:
a secret-key protocol co-operating with an ephemeral secret key K;
a symmetrical cryptographic MAC function μ_{K} co-operating with a hash function HASH₁ defined by a compression function H₁ and a constant IV₁, and with a hash function HASH₂ defined by a compression function H₂ and a constant IV₂; and
a program identifier ID stored in the electronic object XμP and corresponding to hashing of P;
wherein said public-key protocol comprises the following stages:
a) an initialization stage during which the XμP generates an ephemeral key K, then receives from the XT the set of programs P, the number of instructions F and its identifier ID, computes the hash h of said program P with the HASH₁ function, by using the compression function H₁ and the constant IV₁, and finally generates signatures σᵢ, by means of the μ_{K} function and of the key K, which signatures σᵢ it transmits to the XT;
b) an execution phase during which the XμP checks that h and ID are equal, also verifies that ID is stored in its non-volatile memory, and then requests, one after the other, the instructions of P so as to execute them, and, for some of them, performs a sub-stage of verification that consists in requesting a signature σ, constructed on the basis of the signatures σᵢ generated during the initialization stage and by means of the HASH₂ function, and in verifying said signature σ;
c) a reaction stage that takes place whenever a signature σ is not valid.

2. A method of making instructions of an electronic portable object secure according to claim 1, wherein the sub-stage of verification in the execution stage is verification of the signature σ taking place prior to execution of each instruction.

3. A method of making instructions of an electronic portable object secure according to claim 2, wherein the execution stage comprises the following sub-stages:
b-1) the XμP requests an instruction from the XT;
b-2) the XμP requests a signature σ constructed on the basis of the signatures σᵢ generated during the initialization stage and by means of the HASH₂ function, and, in the event that said signature σ is not valid, executes the reaction stage; and
b-3) the XμP executes the instruction and returns to the sub-stage b-1.

4. A method of making instructions of an electronic portable object secure according to claim 1, wherein the sub-stage of verification in the execution stage is verification of the signature σ taking place prior to execution of the instruction, if said instruction is an instruction that is critical for security.

5. A method of making instructions of an electronic portable object secure according to claim 4, wherein the execution stage comprises the following sub-stages:
b-1) the XμP requests an instruction from the XT;
b-2) if said instruction is critical for security, the XμP requests a signature σ constructed on the basis of the signatures σᵢ generated during the initialization stage and by means of the HASH₂ function, and, in the event that said signature σ is not valid, executes the reaction stage; and
b-3) the XμP executes the instruction and returns to the sub-stage b-1.

6. A method of making an electronic portable object secure according to claim 1, wherein the sub-stage of verification in the execution stage is verification of the signature σ taking place prior to execution of the instruction if said instruction is an instruction that is critical for security, and if at least one of the items of data used for said instruction is a secret item of data.

7. A method of making instructions of an electronic portable object secure according to claim 6, wherein it uses a variable Φ defining the set of security levels defined at a given instant by execution of a given program P, and in that the execution stage comprises the following sub-stages:
b-1) the XμP requests an instruction from the XT;
b-2) if said instruction is critical for security and if at least one of the items of data used by the instruction is secret, then the XμP requests a signature σ constructed on the basis of the signatures σᵢ generated during the initialization stage and by means of the HASH₂ function, and, in the event that said signature σ is not valid, executes the reaction stage; and
b-3) the XμP executes the instruction, updates the security level (secret or non-secret data) of each of the items of data coming from the execution, and returns to the sub-stage b-1.

8. A method of making instructions of an electronic portable object secure according to claim 7, that wherein it uses a variable Φ defining the set of security levels defined at a given instant by execution of a given program P, in that it uses an Alert Boolean function, and in that the execution stage comprises the following sub-stages:
b-1) the XμP requests an instruction from the XT;
b-2) if said instruction is critical for security and if the Alert Boolean function determined on the basis of the security level of the data used by the instruction and by the nature of the instruction itself is evaluated as TRUE, then the XμP requests a signature σ constructed on the basis of the signatures σᵢ generated during the initialization stage and by means of the HASH₂ function, and, in the event that said signature σ is not valid, executes the reaction stage; and
b-3) the XμP executes the instruction, updates the security level (secret or non-secret data) of each of the items of data coming from the execution, and returns to the sub-stage b-1.

9. A method of making instructions of an electronic portable object secure according to claim 1, wherein it uses a HASH₃ function defined by a compression function H₃ and a constant IV₃, and in that the program P is supplied in the form of a succession of G sections or blocks of instructions, G thus denoting the number of sections of said program.

10. A method of making instructions of an electronic portable object according to claim 9, wherein said protocol comprises the following stages:
a) an initialization stage during which the XμP generates an ephemeral key K, then receives from the XT the entire set of the program P, its number of sections G and its identifier ID, computes the hash h of said program P with the HASH₁ function, by using the compression function H₁ and the constant IV₁, and with the HASH₃ function, by using the compression function H₃ and the constant IV₃, and finally generates signatures σⱼ, by means of the μ_{K} function and of the key K, which signatures σⱼ it transmits to the XT;
b) an execution phase during which the XμP checks that h and ID are equal, also verifies that ID is stored in its non-volatile memory, and then requests, one after the other, the sections of P so as to execute them, and, for some of them, performs a sub-stage of verification that said sections comply, and then finally, for the final instruction of certain sections, performs a sub-stage of verification that consists in requesting a signature σ, constructed on the basis of the signatures σᵢ generated during the initialization stage and by means of the HASH₂ function, and in verifying said signature; and
c) a reaction stage that takes place whenever a signature σ is not valid or whenever a section does not comply.

11. A method of making instructions of an electronic portable object secure according to claim 10, wherein the sub-stage of verification that a given section complies consists in verifying that no instruction of that section, except possibly for the last instruction, is an instruction that is critical for security.

12. A method of making instructions of an electronic portable object secure according to claim 11, wherein the sub-stage of verification in the execution stage is verification of the signature σ taking place prior to execution of the final instruction of each section.

13. A method of making instructions of an electronic portable object secure according to claim 12, wherein the execution stage comprises the following sub-stages:
b-1) the XμP requests a section from the XT;
b-2) for each non-final instruction of the requested section, the XμP verifies whether said instruction is critical, and, if it is, performs the reaction phase, and, otherwise, executes said instruction and goes to the next instruction;
b-3) for the final instruction of the requested section:
b-31) the XμP requests a signature σ constructed on the basis of the signatures σⱼ generated during the initialization stage and by means of the HASH₂ function, and, in the event that said signature σ is not valid, executes the reaction stage; and
b-32) the XμP executes the instruction;
b-4) the XμP then returns to the sub-stage b-1.

14. A method of making instructions of an electronic portable object secure according to claim 11, wherein the sub-stage of verification in the execution stage is verification of the signature σ taking place prior to execution of the final instruction of each section, if said instruction is an instruction that is critical for security.

15. A method of making instructions of an electronic portable object secure according to claim 14, wherein the execution stage comprises the following sub-stages:
b-1) the XμP requests an instruction from the XT;
b-2) for each non-final instruction of the requested section, the XμP verifies whether said instruction is critical, in which case it performs the reaction stage, and otherwise it executes said instruction and goes on to the next instruction;
b-3) for the final instruction of the requested section:
b-31) if the instruction is critical for security, the XμP requests a signature σ constructed on the basis of the signatures σⱼ generated during the initialization stage and by means of the HASH₂ function, and, in the event that said signature σ is not valid, executes the reaction stage; and
b-32) the XμP executes the instruction; and
b-4) the XμP then returns to the sub-stage b-1.

16. A method of making instructions of an electronic portable object secure according to claim 11, wherein the sub-stage of verification in the execution stage is verification of the signature σ taking place prior to execution of the final instruction of each section, if said instruction is an instruction that is critical for security, and if at least one of the items of data used by said instruction is a secret item of data.

17. A method of making instructions of an electronic portable object secure according to claim 16, wherein it uses a variable Φ defining the set of security levels defined at a given instant by execution of a given program, and in that the execution stage comprises the following sub-stages:
b-1) the XμP requests an instruction from the XT;
b-2) for each non-final instruction of the requested section, the XμP verifies whether said instruction is critical, in which case it performs the reaction stage, and otherwise it executes said instruction and goes on to the next instruction;
b-3) for the final instruction of the requested section:
b-31) if the instruction is critical for security, and if at least one of the items of data used by the instruction is secret, the XμP requests a signature σ constructed on the basis of the signatures σⱼ generated during the initialization stage and by means of the HASH₂ function, and, in the event that said signature σ is not valid, executes the reaction stage; and
b-32) the XμP executes the instruction;
b-33) the XμP updates the security level (secret data or non-secret data) of each of the items of data coming from the execution; and
b-4) the XμP then returns to the sub-stage b-1.

18. A method of making instructions of an electronic portable object secure according to claim 16, wherein it uses a variable Φ defining the set of security levels defined at a given instant by execution of a given program, in that it uses an Alert Boolean function and in that the execution stage comprises the following sub-stages:
b-1) the XμP requests an instruction from the XT;
b-2) for each non-final instruction of the requested section, the XμP verifies whether said instruction is critical, in which case it performs the reaction stage, and otherwise it executes said instruction and goes on to the next instruction;
b-3) for the final instruction of the requested section:
b-31) if the instruction is critical for security, and if the Alert Boolean function determined on the basis of the security level of the data used by the instruction and by the nature of the instruction itself is evaluated as being TRUE, the XμP requests a signature σ constructed on the basis of the signatures σⱼ generated during the initialization stage and by means of the HASH₂ function, and, in the event that said signature σ is not valid, executes the reaction stage; and
b-32) the XμP executes the instruction;
b-33) the XμP updates the security level (secret data or non-secret data) of each of the data coming from the execution; and
b-4) the XμP then returns to the sub-stage b-1.

19. A method of making instructions of an electronic portable object secure according to claim 4 at least one of the following types of instruction are critical for security:
the test instructions and/or
the instructions issuing information to the outside via communications means and/or
the instructions modifying the contents of the non-volatile memory and/or
the computation instructions presenting special cases during execution of them, such as the launch of exceptions.

20. A method of making instructions of an electronic portable object secure according to claim 8, wherein the Alert Boolean function is evaluated as being TRUE for at least one of the following types of instruction:
the test instructions and/or
the instructions issuing information to the outside via communications means and/or
the instructions modifying the contents of the non-volatile memory and/or
the computation instructions presenting special cases during execution of them, such as the launch of exceptions.

21. A method of making instructions of an electronic portable object secure according to claim 8, wherein the Alert Boolean function is evaluated as being TRUE for at least one of the following types of instruction, if at least one of the input items of data is secret, and as being FALSE if all of the items of data tested are public:
the test instructions and/or
the instructions issuing information to the outside via communications means and/or
the instructions modifying the contents of the non-volatile memory and/or
the computation instructions presenting special cases during execution of them, such as the launch of exceptions.

22. A method of making instructions of an electronic portable object secure according to claim 7 the set of security levels Φ used during execution of a program P is indicated by the value of a function φ, such that, for any item of data u used by the program, φ(u)=0 designates the fact that u is public and φ(u)=1 designates the fact that u is private, and such that, for any item of data v resulting from execution of an instruction of the program P, φ(v)=1 if at least one of the items of input data of the instruction is private, and, otherwise φ(v)=0.

23. A method of making instructions of an electronic portable object secure according to claim 22, wherein the values of the function φ are computed by means of hardware implementation of a “Logic OR” function implemented on the values of the φ function for the input data of the instructions.

24. A method of making instructions of an electronic portable object secure according to claim 1, wherein the hash functions HASH₁, HASH₂, and HASH₃ are identical.

25. An electronic object, wherein it implements claim 1.

26. The method of claim 24 wherein said instructions contain data that can be executed by XT and data that cannot be executed by XT.
